(19) United States
(12) Patent Application Publication
(10) Pub. No.: US 2025/0323839 A1
(43) Pub. Date: Oct. 16, 2025

(54) METHODS AND APPARATUS TO LEVERAGE ARTIFICIAL INTELLEGENCE TO DETERMINE ENERGY USAGE OF CELLULAR COMMUNICATION SYSTEMS

(71) Applicants: Wei Mao, Pleasanton, CA (US); Hosein Nikopour, San Jose, CA (US); Omid Semiari, Santa Clara, CA (US); Lili Wei, Tucson, AZ (US); Shu-ping Yeh, San Jose, CA (US)

(72) Inventors: Wei Mao, Pleasanton, CA (US); Hosein Nikopour, San Jose, CA (US); Omid Semiari, Santa Clara, CA (US); Lili Wei, Tucson, AZ (US); Shu-ping Yeh, San Jose, CA (US)

(21) Appl. No.: 19/252,941

(22) Filed: Jun. 27, 2025

Related U.S. Application Data
(60) Provisional application No. 63/786,804, filed on Apr. 10, 2025.

(51) Int. Cl. H04L 41/16; H04L 41/0813; H04W 28/02

(52) U.S. Cl. CPC H04L 41/16; H04L 41/0813; H04W 28/0268

(57) ABSTRACT

Systems, apparatus, articles of manufacture, and methods are disclosed. An example apparatus includes interface circuitry, machine-readable instructions, and at least one programmable circuit to be programmed by the machine-readable instructions to: execute a machine learning model based on performance data corresponding to a base station device to determine a configuration that includes at least one of a duration of an active period or a duration of a nonactive period, the base station device to consume a first amount of power during the active period and a second amount of power during the nonactive period, the second amount less than the first amount, and deploy the configuration to the base station device.

### RELATED APPLICATION

This patent claims the benefit of U.S. Provisional Patent Application No. 63/786,804, which was filed on Apr. 10, 2025. U.S. Provisional Patent Application No. 63/786,804 is hereby incorporated herein by reference in its entirety. Priority to U.S. Provisional Patent Application No. 63/786,804 is hereby claimed.

### FIELD OF THE DISCLOSURE

This disclosure relates generally to cellular communication and, more particularly, to methods and apparatus to leverage artificial intelligence to determine energy usage of cellular communication systems.

### BACKGROUND

Cellular towers are nodes within a Radio Access Network (RAN) that wirelessly connect user equipment (UE) devices to a core network such as the Internet. In recent years, the number of UE devices within a given RAN have increased. UE devices include cell phones, tablets, laptops, smart watches, security cameras, etc.

### BRIEF DESCRIPTION OF THE DRAWINGS

FIG. 1 is a block diagram of an example environment in which Near Real Time Radio Access Network Intelligent Controller (Near-RT RIC) circuitry operates to determine cycle configurations.

FIG. 2 is an example of operations periods for the cells of FIG. 1.

FIG. 3 is an example of power modes for the cells of FIG. 1.

FIG. 4 is a graph showing example performances of a cell of FIG. 1.

FIG. 5 is a block diagram of an example implementation of the Near-RT RIC circuitry of FIG. 1.

FIG. 6 is a flowchart representative of example machine-readable instructions and/or example operations that may be executed, instantiated, and/or performed by example programmable circuitry to implement the Near-RT RIC circuitry of FIG. 5.

FIG. 7 is a flowchart representative of example machine-readable instructions and/or example operations that may be executed, instantiated, and/or performed by example programmable circuitry to add an entry to the experience replay buffer as described in FIG. 6.

FIG. 8 is a flowchart representative of example machine-readable instructions and/or example operations that may be executed, instantiated, and/or performed by example programmable circuitry to implement an action and obtain RAN data as described in FIG. 6.

FIG. 9 is a flowchart representative of example machine-readable instructions and/or example operations that may be executed, instantiated, and/or performed by example programmable circuitry to adjust the Q-network using the experience replay buffer as described in FIG. 6.

FIG. 10 is a block diagram of an example processing platform including programmable circuitry structured to execute, instantiate, and/or perform the example machine-readable instructions and/or perform the example operations of FIGS. 6-9 to implement the Near-RT RIC circuitry 108 of FIG. 5.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine-readable instructions of FIGS. 6-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

As cellular technology evolves, industry members have increased their UE-level (User Endpoint-level) Quality of Service (QOS) requirements to support emerging wireless applications (e.g., including but not limited to autonomous vehicles, Internet of Things (IoT) applications, etc.). These heightened QoS requirements force Radio Area Networks (RANs) to, among other things, support strict performance guarantees related to delay-sensitive data traffic.

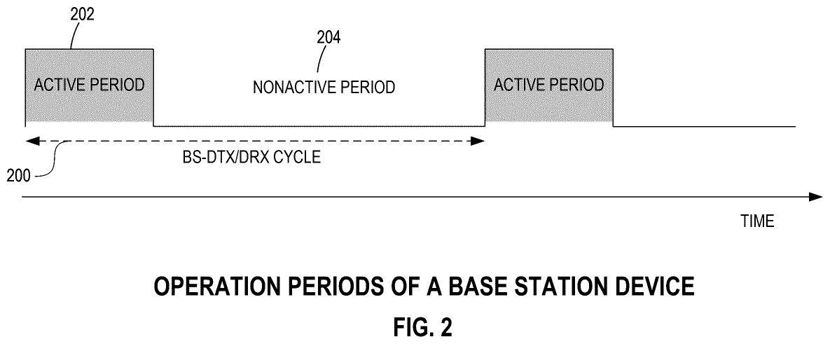

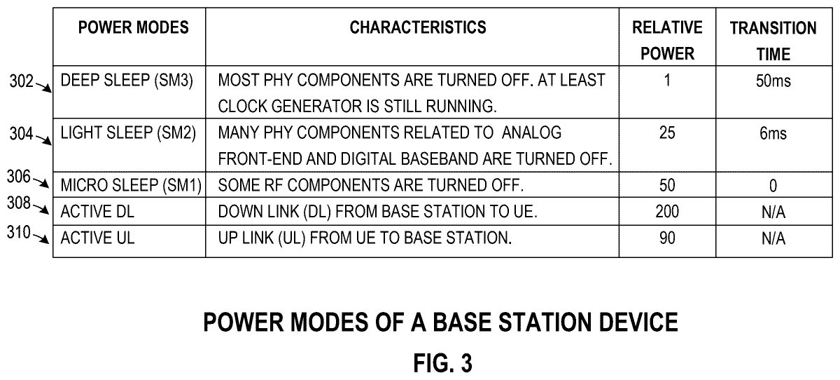

Devices within a RAN seek to meet the foregoing heightened QoS requirements in an energy efficient manner. For example, base station (BS) devices can implement discontinuous transmission/discontinuous reception (DTX/DRX) mechanisms by periodically enter one of multiple sleep modes, thereby saving energy compared to other base station devices that idle at full power. As used above and herein, a BS-DTX/DRX mechanism refers to a base station device entering and exiting various sleep states as described further in connection with FIGS. 2 and 3. Examples of BS-DTX/DRX cycles include but are not limited to the cell-DTX/DRX standard described by the 3rd Generation Partnership Project (3GPP) Release 18 standard.

Any packet that a UE device sends to a base station device during its sleep mode must wait to reach the core network until the base station device exits the sleep mode and returns to full power. Thus, in some examples, the BS-DTX/DRX cycle introduce delays that are approximately proportional to the duration of the sleep mode. Moreover, BS-DTX/DRX cycles present a tradeoff between achieving QoS for delay-sensitive traffic and saving additional energy. In some examples, a base station device may inadvertently operate in a state in which the ratio between time in sleep mode and time in full-power mode is too large to timely deliver all packets that arrive within a cycle, thereby jeopardizing the cell's ability to meet QoS requirements for delay-sensitive traffic. On the other hand, if the ratio between time in sleep mode and time in full-power mode is sufficiently small, then the base station device may not have enough time to enter lower power (e.g., deeper sleep) modes and energy savings are reduced.

Known industry techniques to improve RAN efficiency focus on saving energy by moving various components of a UE device into a sleep mode. While beneficial to the performance of the UE device, such techniques do not address the performance of base station devices (e.g., devices on cell towers that function as intermediate devices to transfer data to/from UE devices). Moreover, such known energy techniques are not transferrable from UE devices to base station devices because the two groups of devices have different roles and requirements within a RAN, perform different operations, and are implemented using different components.

Example methods, apparatus, and systems disclosed herein enable cell towers to leverage AI to improve the BS-DTX/DRX cycle configuration by striking a balance between QoS support and energy savings. Example Near-RT RIC circuitry implements an Artificial Intelligence (AI) agent (e.g., a machine learning model) that is trained using Reinforcement Learning techniques. In some such examples, a contextual multi-armed bandit agent and a Deep-Q Neural Network are leveraged. The Near-RT RIC circuitry populates an experience replay buffer by monitoring cell tower performance and collecting RAN data, performance metrics, and power metrics of a tower that implements BS-DTX/DRX cycle configurations. The Near-RT RIC circuitry periodically and/or a-periodically trains the AI agent using the data collected in the experience replay buffer and a reward function that characterizes the performance and power consumption of the tower. As a result, the trained AI agent generates BS-DTX/DRX configurations that move a base station device into sleep mode for a duration that is as long as possible (thereby enabling the base station device to enter a deeper sleep mode and save more energy) while still supporting the QoS requirements for delay-sensitive traffic. In some examples, the BS-DTX/DRX configurations produced by the AI agent disclosed are referred to as optimized because the agent maximizes what energy savings are possible when supporting delay-sensitive traffic QoS constraints. In some examples, the terms “AI agent,” “machine learning model,” and “AI model” may be used interchangeably.

As used herein “near real time” refers to occurrence in a near instantaneous manner recognizing there may be real world delays for computing time, transmission, etc. Thus, unless otherwise specified, “near real time” refers to real time+an amount of time between 10 milliseconds (ms) and 1 second.

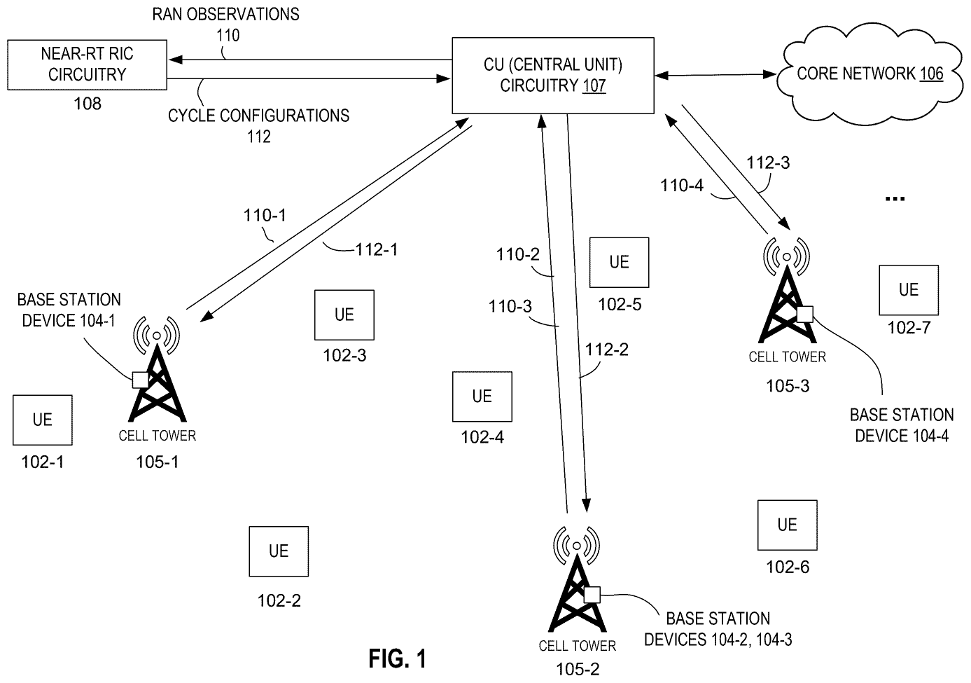

FIG. 1 is a block diagram of an example Radio Access Network (RAN). FIG. 1 includes example User Equipment (UE) devices 102-1, 102-2, 102-3, 102-4, 102-5, 102-6, 102-7, . . . (collectively referred to as UE devices 102), example base station devices 104-1, 104-2, 104-3, 104-4 (collectively referred to as base station devices 104), example cell towers 105-1, 105-2, 105-3, . . . (collectively referred to as cell towers 105), an example core network 106, example central unit (CU) circuitry 107, and example Near-RT RIC circuitry 108. FIG. 1 also includes example RAN observations 110-1, 110-2, 110-3, 110-4 . . . (collectively referred to as RAN observations 110), and example cycle configurations 112-1, 112-2, 112-3, . . . (collectively referred to as cycle configurations 112).

The UE devices 102 refer to any devices that rely on one or more of the base station devices 104 to connect to the core network 106. Once connected, a given UE device 102-1 may perform any type of data communication with the core network 106. Examples of such communication include but is not limited to fourth generation (4G) or fifth generation (5G) Internet browsing, Short Message Service (SMS) or Multimedia Messaging Service (MMS) texting, second generation (2G) or third generation (3G) phone calls, etc. In some examples, a UE device 102-1 is referred to as a client device.

UE devices include but are not limited to cell phones, tablets, laptops, smart watches, security cameras, Virtual Reality (VR)/Augmented Reality (AR) headsets, etc. More generally, UE devices may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The base station devices 104 are intermediary devices that connect the UE devices 102 to the core network 106. At a high level, a given base station device 104-1 does so by a) receiving data from its assigned UE devices and forwarding said data to the core network 106 and b) receiving data from the core network 106 and forwarding said data to one of its assigned UE devices. The base station devices 104 may include any combination of hardware, software, and/or firmware to support such operations, including but not limited to any form of programmable circuitry, machine-readable instructions, and one or more antennas. In the example of FIG. 3, the four base station devices 104 are implemented across three cell towers 105. More generally, any number of base station devices 104 may be implemented at the same cell tower. In such examples, base station devices that are implemented at the same location operate at different frequencies to provide both coverage and capacity to meet the traffic demand. In some examples, the base station devices 104 are implemented by a combination of Distributed Unit (DU) circuitry and Radio Unit (RU) circuitry as defined by the O-RAN Alliance standards.

The core network 106 connects the UE devices 102, via the CU circuitry 107, to other devices in a wide area (e.g., on a global scale) in a manner that supports Internet access, text messaging, voice calls, etc. In this example, the core network 106 is the Internet. However, the example core network 106 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The example of FIG. 1 shows the RAN observations 110 and the cycle configurations 112 correspond to four base station devices 104 that collectively connect seven UE devices 102 to the core network 106. More generally, the near-RT RIC circuitry 108 may obtain RAN observations 110 and deploy cycle configurations 112 to any number of base station devices 104, and the base station devices 104 may connect any number of UE devices 102 to the core network 106.

The CU circuitry 107 is an intermediary device that supports higher layers of the 5GNR protocol stack (e.g., the Service Data Adaption Protocol (SDAP), the Packet Data Convergence Protocol (PDCP), the RRC (Radio Resource Control) protocol, etc.). For example, in FIG. 1, the CU circuitry 107 collects the RAN observations 110 from the base station devices 104 and forwards said data to the near-RT RIC circuitry 108. The CU circuitry 107 also forwards the cycle configurations 112 from the near-RT RIC circuitry 108 to the 104 base station devices. The CU circuitry 107 also provides the UE devices 102 with 5G New Radio (5GNR) access to the core network 106. The CU circuitry 107 may be implemented by any type of programmable circuitry.

The Near-RT RIC circuitry 108 manages the operations of the base station devices 104. For example, the Near-RT RIC circuitry 108 obtains RAN observations 110-1, 110-2, 110-3, 110-4 from each of the base station devices 104. The RAN observations 110 include measurements that characterize the traffic and transmission conditions at the base station device, as described further below. The Near-RT RIC circuitry 108 uses the RAN observations 110 to train an AI agent to produce the cycle configurations 112. A given cycle configuration 112-1 describes how a corresponding base station device 104-1 operates during a BS-DTX/DRX cycle (e.g., how much time to spend in one or more states including an action state and/or one or more sleep states having targeted different energy consumption profiles). The trained AI agent may be executed to perform inference operations at the Near-RT RIC circuitry 108, and/or may be executed at one or more of the cell towers 105 by one or more of the base station devices 104. Similarly, although the above describes training at the Near-RT RIC circuitry 108, training could be done locally by the base station devices 104 based on local data so that each base setation device has its own AI model trained on its local data.

In some examples, a cycle configuration 112 is referred to as an action because implementing the action onto a base station device 104 changes the behavior of the RAN. In some examples, the phrases “implement an action” and “deploy a configuration” may be used interchangeably to refer to when the Near-RT RIC circuitry 108 provides a base station device 104-1 with instructions that change how the base station device 104-1 operates during a BS-DTX/DRX cycle.

The Near-RT RIC circuitry 108 may be implemented by one or more programmable circuit and by any type of programmable circuitry. In some examples, the CU circuitry 107 and the Near-RT RIC circuitry 108 are implemented in the same edge cloud device. The Near-RT RIC circuitry 108 is described further in connection with FIG. 2.

FIG. 2 is an example of operation periods for the base station devices of FIG. 1. FIG. 2 shows the example BS-DTX/DRX cycle 200 includes an example active period 202 and an example nonactive period 204.

The active period 202 within a BS-DTX/DRX cycle 200 refers to the duration of time when the base station device 104-1 operates normally to facilitate fully functional communication between the base station device 104-1 and the UE devices 102. For example, both a) receiver components that receive data from the UE devices 102 and b) transmitter components that send data to the UE devices 102 are powered on and capable of performing operations during the active period 202. In some examples, the active period 202 is referred to as a full-power mode because the base station device 104-1 consumes the most power to achieve the most amount of functionality during this time. The specific modes within the active period 202 are described further in connection with FIG. 3.

The nonactive period 204 within a BS-DTX/DRX cycle 200 refers to a duration of time when the base station device 104-1 turns off one or more components, thereby entering a lower power mode (which may also be referred to as a sleep mode) where energy savings occur but functionality between the base station device 104-1 and the UE devices 102 is limited. For example, the base station devices 104 are unable to forward data from the core network 106 to the UE devices 102 during the nonactive period 204. However, the base station devices 104 do continue to support synchronization signal block (SSB) transmission, random access procedure, paging and system information broadcast, etc., to maintain basic operations during the nonactive period. Example sleep modes in which the base station devices 104 perform various amounts of receiving and caching data from UE devices 102 within the nonactive period 204 are described further in connection with FIG. 3.

Typically, base station devices 104 operate by continuously repeating the BS-DTX/DRX cycle 200 in a periodic manner. Accordingly, a second instance of the BS-DTX/DRX cycle 200 begins as soon as a first instance of the BS-DTX/DRX cycle 200 ends. In this example, a given instance of the BS-DTX/DRX cycle 200 is composed of the active period 202 and the nonactive period 204. Accordingly, the duration of a BS-DTX/DRX cycle 200 is equal to the sum of a) the duration of the active period 202 and b) the duration of the nonactive period 204.

In some examples, a given cycle configuration 112-1 changes a) the duration of the active period 202 and b) the duration of the nonactive period 204 but does not change the total duration of the BS-DTX/DRX cycle. In such examples, any increase in the duration of the active period 202 results in a decrease of equal magnitude in the duration of the nonactive period 204 and vice versa. Therefore, a cycle configuration 112-1 changes the ratio of active period duration to nonactive period duration in such examples.

In other examples, the cycle configurations 112 change the total duration of the BS-DTX/DRX cycle. In such other examples, a given cycle configuration can change the duration of the active period 202 without making an equal and opposite change to the duration of the nonactive period 204, and vice versa. In some such examples, change to the total duration of the BS-DTX/DRX cycle results in changes to the durations of both the active period and the nonactive period.

FIG. 3 is an example of power modes for the base station devices 104 of FIG. 1. FIG. 3 shows a table with example rows 302, 304, 306, 308, 310. Each of the rows 302-310 includes the name of a power mode that can be implemented by the base station devices 104, characteristics of the power mode, the relative power of the power mode, and the transition time associated with the power mode.

The row 302 describes the deep sleep mode. In some examples, deep sleep is referred to as sleep mode 3 (SM3). When a base station device 104-1 is operating in deep sleep mode, most of the PHY component within the base station are turned off. As used above and herein, a PHY component refers to an interface circuit that receives data from, and/or transmits data to, an external device using the physical (PHY) layer of the Open Systems Interconnection (OSI) model. PHY components are used to implement communication protocols including but not limited to Ethernet, Wireless Fidelity (Wi-Fi), Universal Serial Bus (USB), Infrared Data Association (IrDA), Serial AT Attachment (SATA), etc.

Because most of the PHY components within a base station device 104-1 are turned off during deep sleep mode, the ability of the base station device 104-1 to perform downlink (DL) transmission and uplink (UL) reception is more limited during the deep sleep mode than any of the other power modes shown in FIG. 3. However, a given base station device 104-1 keeps at least its clock generator circuitry powered on (and, in some examples, additionally keeps other components powered on) during deep sleep mode so that the base station device 104-1 retains the ability to determine when to exit deep sleep mode.

The row 302 also shows that deep sleep mode has a relative power of 1. In this example, the relative power values have arbitrary units and describe how much power the base station devices 104 consume in each power mode relative to the other power modes shown in the table of FIG. 3. Thus, the base station devices 104 consume less power in the deep sleep mode than in any of the light sleep, micro sleep, active DL, or active UL modes because the relative power (1) of deep sleep mode is the smallest value.

In some examples, the base station devices 104 require a nonzero amount of time to transition from a higher power mode to a lower power mode (e.g., to enter a sleep mode). The base station devices 104 may similarly require a nonzero amount of time to transition from the lower power mode to a higher power mode (e.g., to exit a sleep mode). As used herein, the term “transition time” refers to the sum of a) the time required to enter a sleep mode and b) the time required to exit the sleep mode. The transition time is part of the nonactive period 204 within a BS-DTX/DRX cycle 200. Accordingly, the duration of a nonactive period 204 is equal to the sum of a) the transition time for a sleep mode SM1, SM2, or SM3 as described in FIG. 3 and b) the amount of time spent within said sleep mode.

The row 302 shows the transition time of deep sleep mode is approximately 50 milliseconds (ms). Accordingly, if the Near-RT RIC circuitry 108 provides a cycle configuration 112-2 that instructs the corresponding base station device 104-2 to enter deep sleep mode, the duration of the nonactive period 204 within the cycle configuration 112-2 is greater than or equal to 50 ms.

In some examples, the Near-RT RIC circuitry 108 provides cycle configurations 112-2 where the duration of the nonactive period 204 is at least twice as long as the transition time for a desired sleep mode so that the base station device 104-1 spends at least as much time within a desired sleep mode as it does entering into and exiting from said sleep mode. The Near-RT RIC circuitry 108 may impose such a restriction so that the amount of energy savings that occur within the sleep mode justify the delays occurred during the transition time (e.g., when both energy savings and performance are comparatively limited).

The row 304 describes the light sleep mode. In some examples, deep sleep is referred to as sleep mode 2 (SM2). When a base station device 104-1 is operating in light sleep mode, many PHY components within the base station device related to analog front end (AFE) and digital baseband operations are turned off. However, the base station device 104-1 keeps more PHY components powered on during light sleep mode than during deep sleep mode. As a result, the base station devices 104 consume approximately 25 times more power when in light sleep mode than when in deep sleep mode (as 25/1=25). Turning fewer PHY components off, however, reduces the transition time of the light sleep mode compared to the deep sleep mode. The row 304 shows the transition time of the light sleep mode is approximately 6 ms.

The row 306 describes the micro sleep mode. In some examples, micro sleep is referred to as sleep mode 1 (SM1). When a base station device 104-1 is operating in micro sleep mode, some Radio Frequency (RF) components within the base station device are turned off. Examples of such RF components include but are not limited to antennas, amplifier circuits, mixer circuits, oscillator circuits, attenuator circuits, etc. However, the base station devices 104 generally keep most (or, in some examples, all) of their PHY components powered on while in micro sleep mode. As a result, micro sleep mode consumes 50 times more power than deep sleep mode and consumes twice as much power as light sleep mode. Furthermore, the transition time of micro sleep mode is approximately 0 ms (e.g., the time required for a base station device 104-1 to transition from an active mode to the micro sleep mode is negligible).

The duration of an active period 202 refers to the total amount of time spent within the active DL mode and/or the active UL mode before beginning to transition to a sleep mode. In FIG. 3, the row 308 describes an active downlink (DL) mode. When a base station device 104-1 is operating in active DL mode, the base station device 104-1 transmits data to one or more of the UE devices 102. In some examples, a base station device 104-1 can consume up to approximately 200 times more power in active DL mode than in deep sleep mode, and approximately 4 times more power in active DL mode than in micro sleep mode. The transition time metric as defined above is not applicable to the active DL mode because a) the active DL mode is part of the active period 202 and b) transition time is part of the nonactive period 204.

The row 310 describes an active uplink (UL) mode. When a base station device 104-1 is operating in active UL mode, the base station device 104-1 receives data from one or more of the UE devices 102. In this example, the base station devices 104 consume approximately 90 times more power in active UL mode than in deep sleep mode. Like the active DL mode, the transition time metric is not applicable to the active UL mode.

While the BS-DTX/DRX cycle 200 governs communications between the base station devices 104 and the UE devices 102 as described above, the base station devices 104 communicate with the core network 106 using separate hardware, software, and/or firmware components that are independent of the BS-DTX/DRX cycle 200. Thus, a base station device 104-1 may send or receive data from the core network 106 during any of the power modes shown in FIG. 3.

The table in FIG. 3 explains and quantizes the tradeoff between supporting delay-sensitive QoS traffic and saving energy described above. For example, if the core network 106 sends data to a base station device 104-1 during a period when the base station device 104-1 cannot forward the data to a UE device 102-1, the base station device 104-1 stores the data in a DL buffer until a period occurs when such forwarding is possible. The time which data spends in the DL buffer is considered a delay that jeopardizes the ability of the base station device 104-1 to meet QoS requirements.

The DL buffer within the base station device 104-1 has a maximum size (e.g., is implemented by a pre-defined amount of memory). Values are added to the DL buffer independently of the BS-DTX/DRX cycle 200 (e.g., whenever the core network 106 transmits a packet to a base station device) but can only be removed from the DL buffer during the active DL mode. However, the rate at which values are added to the DL memory buffer are based on end user equipment (because the data from the core network 106 is a response to a request originally set by a UE device 102) and therefore not controllable by the Near-RT RIC circuitry 108. Thus, the Near-RT RIC circuitry 108 runs the risk of the DL buffer overflowing if a given configuration 112-1 causes the corresponding base station device 104-1 to operate in active DL mode too infrequently and/or for durations that are too short. More generally, the Near-RT RIC circuitry 108 may jeopardize the ability of the base station 104-1 to meet QoS requirements by operating in either of the active DL mode or the active UL mode too infrequently and/or for durations that are too short. In some examples, the Near-RT RIC circuitry 108 determines a cycle configuration 112-1 satisfaction of the QoS threshold based on an overflow status of a memory buffer (such as the DL buffer) and a proportion of packets that exceed a permitted delay before being delivered.

The foregoing considerations motivate the near-RT RIC circuitry 108 to produce cycle configurations 112 in which the base station devices 104 operate in the active period 202 as frequently and for as long as possible. However, the active DL mode and active UL mode are extremely energy intensive compared to the various sleep modes. Moreover, the RAN conditions in many examples do not require the base station devices 104 to continuously operate in the active period 202 (e.g., because the number of UE devices 102 within a region is relatively low, because the number of base station devices 104 within the region is relatively high, because a particular set of delay-sensitive traffic QOS requirements are relatively lax, etc.). Therefore, the base station devices 104 begin to waste energy (and therefore operate inefficiently) if they remain in the active period 202 more frequently/for longer durations than the conditions of the RAN require. These considerations motivate the Near-RT RIC circuitry 108 to produce cycle configurations 112 in which the frequency and/or duration of the nonactive period 204 is increased. However, the frequency of the active period 202 cannot increase without simultaneously decreasing the frequency of the nonactive period 204 and vice versa.

BS-DTX/DRX cycles provide industry members with flexibility to balance energy savings and performance. For example, suppose the RAN conditions and corresponding delay-sensitive traffic QoS requirements are so demanding that the base station device 104-1 cannot afford spend at least 50 ms entering, staying within, and subsequently existing deep sleep mode and achieving the theoretical maximum amount of energy savings. In such an example, the near-RT RIC circuitry 108 still has the option to instruct the base station device 104-1 to spend a shorter amount of time entering. staying within, and exiting from a different sleep mode (e.g., light sleep or micro sleep). While within the different sleep mode, the base station device 104-1 can continue to meet the delay-sensitive traffic QoS requirements while simultaneously obtaining at least some amount of energy savings.

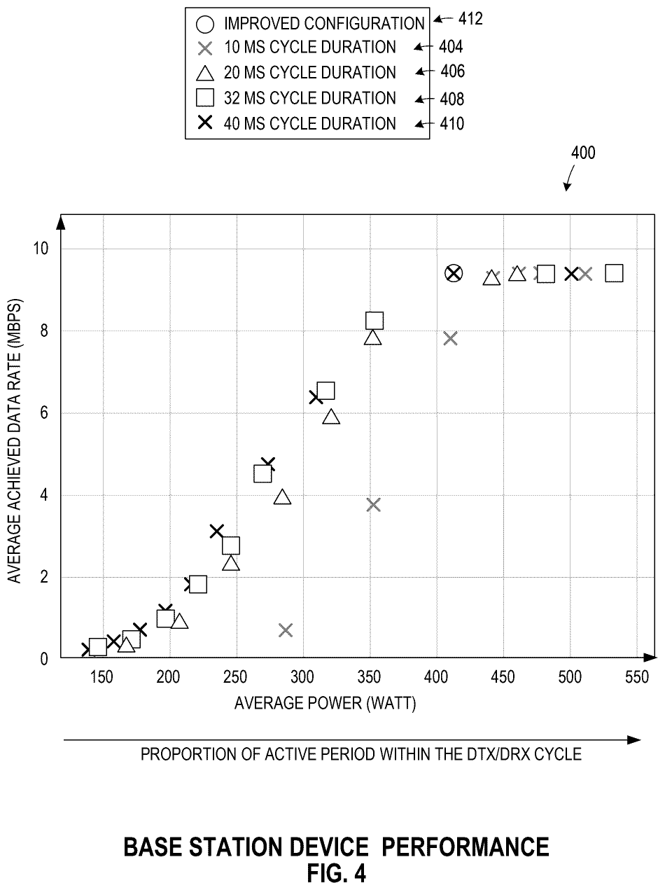

Advantageously, the examples disclosed herein enables the near-RT RIC circuitry 108 to determine cycle configurations in which the amount of energy savings is improved (e.g., maximized) within the restriction that all base station devices 104 continue to meet their delay-sensitive traffic QoS requirements. For instance, FIG. 4 is a graph showing example performances of a base station device (e.g., 104-1) of FIG. 1. The example graph 400 includes an example 10 ms cycle duration data set 404, an example 20 ms cycle duration data set 406, an example 32 ms cycle duration data set 408, an example 40 ms cycle duration data set 410, and an example improved configuration 412. As used herein, the foregoing cycle duration data set may be referred to as n ms data sets 402-410.

For a given data point within a particular n ms data set, the total duration of the BS-DTX/DRX cycle 200 is n ms. The length of each active period 202 within a given n ms data set is different from the other data points within the same set. The length of the active period 202 increases from left to right on the x axis following the sequence (1, 2, 3, 4, 5, 6, 8, 10, 20, 30, 40) ms, provided that a particular sequence value is less than n ms. The foregoing sequence are provided by the 3GPP standard TS38.331. For example, the left-most data point of the 10 ms data set 404 has an active period 202 whose duration is BS-DTX/DRX1 ms (e.g., the first value in the TS38.331 sequence), while the right-most data point of the 10 ms data set 404 has an active period 202 whose duration of 8 ms BS-DTX/DRX (e.g., that largest value in the TS38.331 sequence less than 10 ms). Similarly, the left-most data point of the 40 ms data set 410 has an active period 202 whose duration is BS-DTX/DRX1 ms, while the right-most data point of the 40 ms data set 410 has an active period 202 whose duration is BS-DTX/DRX30 ms. The graph 400 also shows the average power (in Watts) consumed by the base station device 104-1 on the x axis because said value increases as the relative portion of the active period 202 increases.

The y axis of the graph 400 shows the average data rate achieved in megabytes per second (mbps). An increase in the average data rate achieved indicates the base station device 104-1 is able forward a greater number of data packets from the UE devices 102 to the core network 106 and therefore more likely to satisfy delay-sensitive traffic QoS requirements.

The example n ms data sets 402-410 collectively show a trend where, regardless of the length of the BS-DTX/DRX cycle 200, the average achieved data rate generally increases as the proportion of the active period 202 increases to a point. After said point, the performance of the base station device 104-1 generally plateaus such that further increases to the proportion of the active period 202 do not result in significant (or any) increases to the average data rate achieved. Accordingly, the improved configuration 412 for the example performances shown in FIG. 4 occurs when a) the base station device 104-1 has a total BS-DTX/DRX cycle 200 duration of 40 ms and b) the base station device 104-1 operates in the active period 202 for 20 ms of the 40 ms cycle. The configuration is labeled improved because it consumes the lowest amount of power (e.g., approximately 410 W) of those configurations that achieve the highest possible average data rate (e.g., approximately 9.5 Mbps).

While identifying an improved configuration may appear intuitive when viewing the graph 400, identifying an improved configuration using real-world RAN data in a consistent and scalable manner is difficult because the relative positions of the data points within the n ms data sets 402-410 are dependent on a wide variety of RAN conditions and traffic arrival parameters. The improved configuration for a given base station device 104-1 can therefore change in real-time based on any number of factors that include but are not limited to the number of UE devices 102 within a geographic region, the relative location of the UE devices 102 within the geographic region, the amount and type of data being uploaded and/or downloaded by each of the UE devices 102, the number of delay-sensitive traffic QoS requirements, the strictness of both the foregoing QoS requirements and other types of QoS requirements, the performance of other base station devices 104-2, 104-3, . . . within the geographic region, etc. Advantageously, the examples disclosed herein enable the Near-RT RIC circuitry 108 to identify improved configurations using real-world RAN data in a consistent and scalable manner, thereby improving performance over known RAN efficiency improvement techniques by maximizing energy savings of the base station devices 104 while simultaneously supporting delay-sensitive traffic QoS requirements.

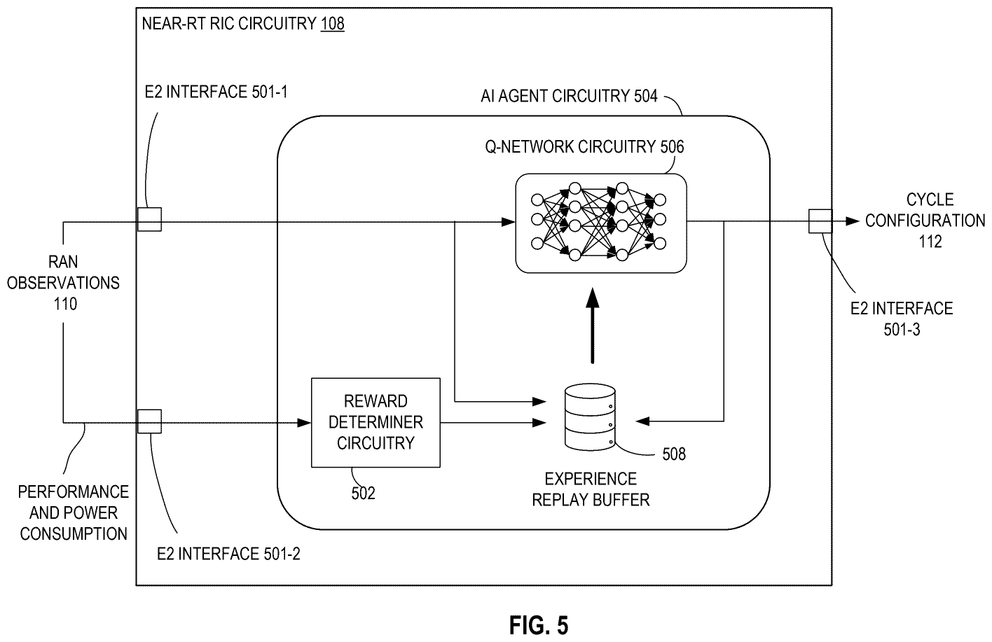

FIG. 5 is a block diagram of an example implementation of the Near-RT RIC circuitry 108 of FIG. 1 to determine the cycle configurations 112. The Near-RT RIC circuitry 108 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the Near-RT RIC circuitry 108 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers. In FIG. 5, the Near-RT RIC circuitry 108 includes example E2 interface circuitry 501-1, 502-2, 502-3 (collectively referred to as E2 interface circuits 501) and example AI agent circuitry 504. The AI agent circuitry 504 includes example reward determiner circuitry 502, example Q-network circuitry 506, and an example experience replay buffer 508.

The AI agent circuitry 504 is implemented in this example by a contextual multi-armed bandit agent that generates the cycle configurations 112 based on the RAN observations 110. The RAN observations 110 include both traffic information (which characterize the flow of data coming into the UL buffer and DL buffers) and RAN transmission conditions (which characterize the flow of data exiting from the UL and DL buffers). The AI agent circuitry 504 seeks to generate the cycle configurations 112 in such a manner that balances both the UL and DL buffers as described above. In the example of FIG. 5, the AI agent circuitry 504 is implemented within the Near-RT RIC circuitry 108. In other examples, the AI agent circuitry 504 is implemented by one or more of the base station devices 104 as described above.

The traffic information within the RAN observations 110 may include base station device traffic intensity statistics as measured by the total amount of data that arrived during an observation period, divided by the duration of BS-DTX/DRX the observation period. As used above and herein, an “observation period” refers to a fixed length of time during which the base station device(s) 104 record measurements about the RAN so that the AI model can be trained on the effects of deploying a cycle configuration 112-1 (e.g., the effects of implementing a given action).

The traffic information within the RAN observations 110 may also include inter-arrival time statistics. For example, a base station device 104-1 may report the mean and variance of the time between each two adjacent packet arrivals during the observation period.

The traffic information within the RAN observations 110 may also include packet size statistics. For example, a base station device 104-1 may report the mean and variance of the sizes of the packets that arrived during the observation period.

The traffic information within the RAN observations 110 may also include traffic delay requirements. For example, a base station device 104-1 may report the minimal and (weighted) average latency requirements of the packets that arrived during the observation period. In some examples, the traffic information within the RAN observations 110 include other parameters in addition to, or in replacement of, one or more of the foregoing parameters.

The RAN transmission conditions within the RAN observations 110 may include base station device transmission capability statistics. A base station device 104-1 may measure such a statistic by dividing its transmitted data by the proportion of radio resource used and averaging the result over the observation period. Examples of radio resource usage include physical resource block (PRB) utilization. In some examples, the RAN transmission conditions include other parameters in addition to, or in replacement of, cell transmission capability.

The AI agent circuitry 504 uses the RAN observations 110 to generate the cycle configurations 112 during both training and inference modes. In some examples, one or more components of the AI agent circuitry 504 are implemented by an xApp, which is a type of software component in the Open RAN (O-RAN) architecture. More generally, the AI agent circuitry 504 may be instantiated by any type of programmable circuitry.

During training mode, the AI agent circuitry 504 uses a reward value as an additional input to generate cycle configurations. The reward determiner circuitry 502 determines reward values based on performance and power metrics within the RAN observations 110. An example of a performance metric used by the reward determiner circuitry 502 is the delivered data ratio yᵣₐₜᵢₒ, which is defined in equation (1):

$${y}_{ratio} = \frac{{y}_{d}}{{y}_{d} + {y}_{f}} \qquad ( 1 )$$

In equation (1), y_{d} is the amount of data contained in the timely received packets (e.g., packets that did satisfy their delay-sensitive QoS requirements) and y_{f} is the amount of data contained in the packets that did not arrive in time to satisfy their delay-sensitive QoS requirements. An example of a power metric used by the reward determiner circuitry 502 is the normalized power consumption x, which is defined in equation (2):

$$x = \frac{average power consumption of the observation period}{maximum possible power consumption} \qquad ( 2 )$$

The reward determiner circuitry 502 may use multiple different techniques to determine a reward value based on the performance and power metrics provided within the RAN observations 110. For example, the reward determiner circuitry 502 may produce a linear reward rₗᵢₙ as defined in equation (3):

$${r}_{lin} = - ( 1 - c ) x - c ( 1 - {y}_{ratio} ) \qquad ( 3 )$$

In equation (3), the term (1−yᵣₐₜᵢₒ) represents the ratio of data that failed to satisfy a delay-sensitive QoS requirement as defined above in equation (1). Equation (3) also includes the constant c, which is a value between 0 and 1 (expressed algebraically as 0≤c≤1). c is an importance weight that represents the tradeoff between QoS performance and energy savings. For example, a value of c closer to 0 causes the AI agent circuitry 504 to create cycle configurations 112 that have a comparatively high emphasis on energy savings (and therefore a comparatively low emphasis on QoS performance), while a value of c closer to 1 causes the AI agent circuitry 504 to create cycle configurations 112 that have a comparatively low emphasis on energy savings (and therefore a comparatively high emphasis on QoS performance).

Using the linear reward of equation (3) can be difficult to scale because a certain value of c may work well for some base station devices (e.g., 104-1, 104-4) but not for other base station devices (e.g., 104-2, 104-3). Accordingly, in some examples, the reward determiner circuitry 502 instead produces a QoS-threshold reward r_{QoS} as defined in equation (4):

$${r}_{QoS} = \{ \begin{matrix}( - ax ) & if {y}_{ratio} \geq {y}_{0} \\ ( {y}_{ratio} - b ) & otherwise\end{matrix} \qquad ( 4 )$$

In equation (4), x and yᵣₐₜᵢₒ have the same definitions described above, while y₀ represents the target data delivery ratio. y₀ which may also be referred to as a QoS threshold. The constants a and b from equation (4) satisfy the inequalities expressed in (5) and (6):

$$0 < a \qquad ( 5 )$$

$$- a \leq ( {y}_{0} - b ) \qquad ( 6 )$$

One example set of values that satisfy (5) and (6) are a=1, b=1+y₀. In such an example, the reward r_{QoS} of equation (4) depends only on yᵣₐₜᵢₒ if the QoS threshold is not satisfied, in which case r_{QoS} places an increased emphasis on improving the delivered data ratio during subsequent training of the AI agent circuitry 504. Alternatively if the QoS threshold is satisfied, then r_{QoS} depends only on x and places an increased emphasis on energy saving during subsequent training of the AI agent circuitry 504.

Modelling r_{QoS} of equation (4) can be difficult because the reward function is discontinuous at yᵣₐₜᵢₒ=y₀. In some examples, equation (4) is referred to as a discontinuous quality of service threshold function. Accordingly, in some examples, the reward determiner circuitry 502 instead produces a first smooth approximation of the discontinuous QoS threshold function. This first smooth approximation, r_{QoS}_smooth, is given by equations (7)-(10):

$${r}_{QoS \_ smooth} = - {( x + u )}^{v} \qquad ( 7 )$$

$$u = {( \frac{1 - {y}_{ratio}}{1 - {y}_{0}} )}^{m} \qquad ( 8 )$$

$$v = \frac{x + u}{x + kum} \qquad ( 9 )$$

$$k = - {log}_{amplitude} ( 1 - {y}_{0} ) \qquad ( 10 )$$

In equations (7)-(10), the values x, yᵣₐₜᵢₒ, and y₀ have the same definitions as described above, while the value amplitude refers to a the maximum amplitude of the reward (e.g., amplitude=2). The constant m in equations (7)-(10) refers to a shape factor that controls the trade-off between smoothness of the reward function and accuracy of the approximation. For example, an increase in the value of m increases the similarity of the values r_{Qos} and r_{Qos_smooth} but decreases the smoothness of the function that defines r_{QoS_smooth}.

In some examples, the reward determiner circuitry 502 instead produces a second smooth approximation. This second smooth approximation, r_{QoS_rolloff}, is given by equations (11) and (12):

$${r}_{QoS\_rolloff} = - \frac{u [ 1 + ( amplitude - 1 ) ( 1 - {y}_{ratio} ) ] + x}{u + 1} \qquad ( 11 )$$

$$u = {[ \frac{1 - {y}_{ratio}}{( 1 - {y}_{0} ) ( 1 - x )} ]}^{m} \qquad ( 12 )$$

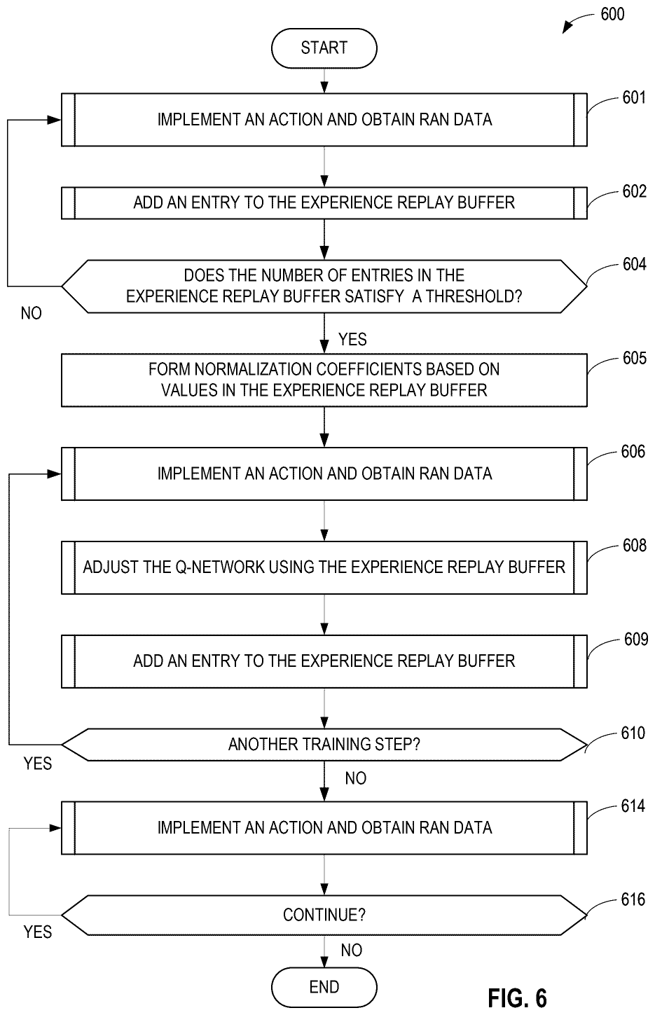

In equations (11) and (12), the values x, yᵣₐₜᵢₒ, y₀, amplitude, and m have the same definitions described above. In some examples, iterations of the AI model trained with the second smooth approximation r_{QoS_rolloff} exhibit better performance than iterations of the AI model trained with the first smooth approximation r_{QoS_smooth}. In some examples, the reward determiner circuitry 502 is instantiated by programmable circuitry executing reward determiner instructions and/or configured to perform operations such as those represented by the flowchart(s) of FIGS. 6-9.

The E2 interface circuits 501 carry events, control, and policy information to and from various O-RAN devices as defined by an O-RAN Alliance standard. In the example of FIG. 5, the AI agent circuitry 504 obtains the RAN observations 110 using the E2 interface circuitry 501-1, obtains the performance and power consumption metrics using the E2 interface circuitry 501-2, and transmits the cycle configurations 112 to the CU circuitry 107 using the E2 interface circuitry 501-3. In some examples, one or more of the E2 interface circuits 501 are implemented using a share set of hardware, software, and/or firmware resources (e.g., the same port, the same PHY components, etc.).

The AI agent circuitry 504 periodically gathers certain RAN measurements from the E2 interface circuitry 501-1 to infer the improved cycle configurations 112 as described above. Thus, use of the same RAN measurements in a periodic pattern can indicate a system is implemented by one or more of the examples disclosed herein.

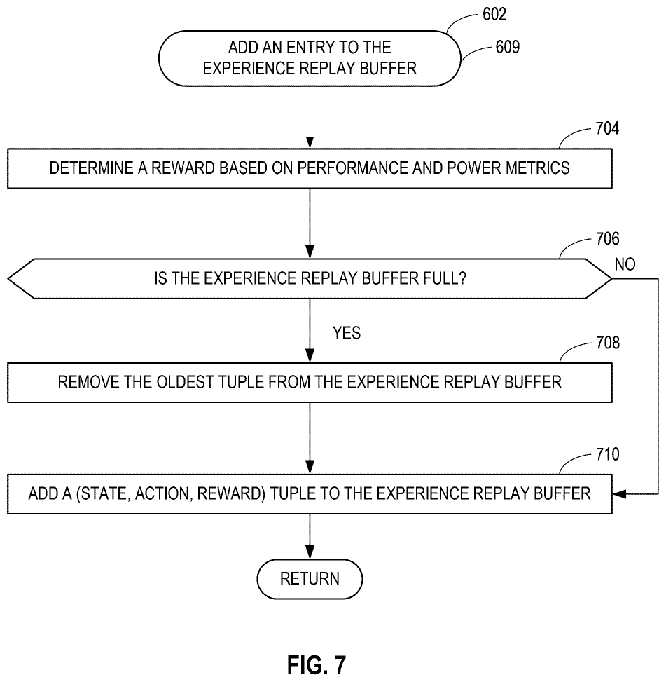

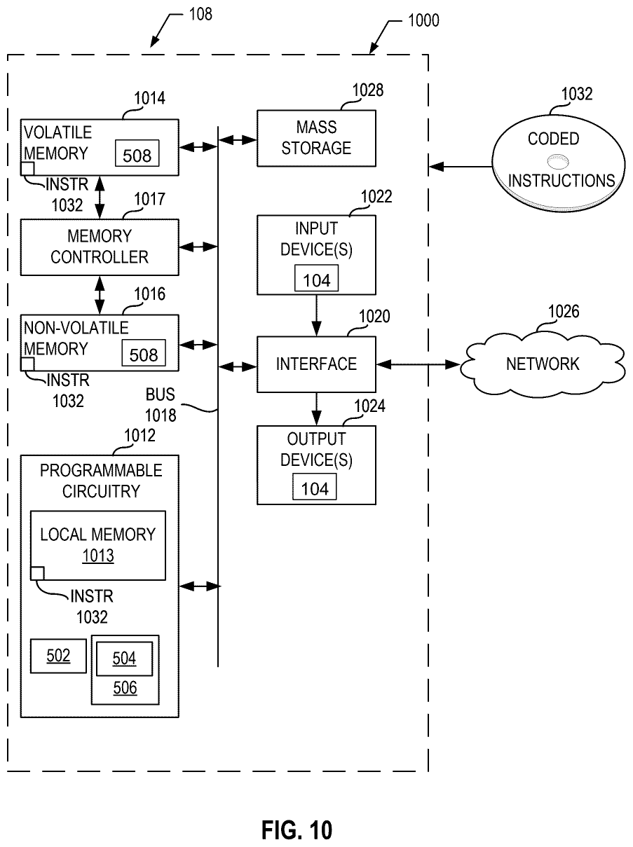

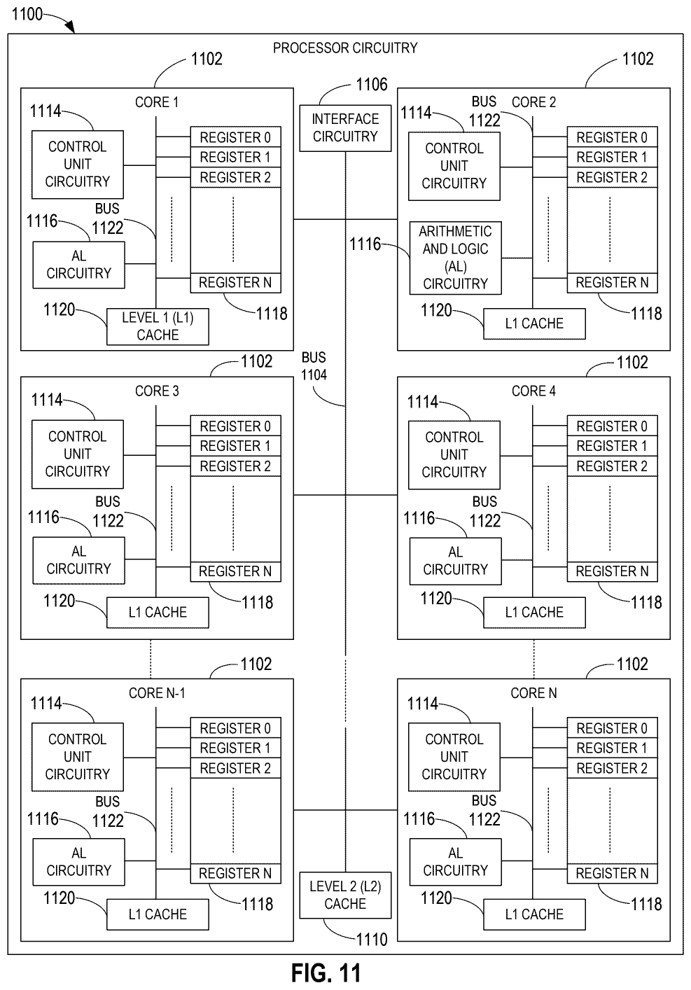

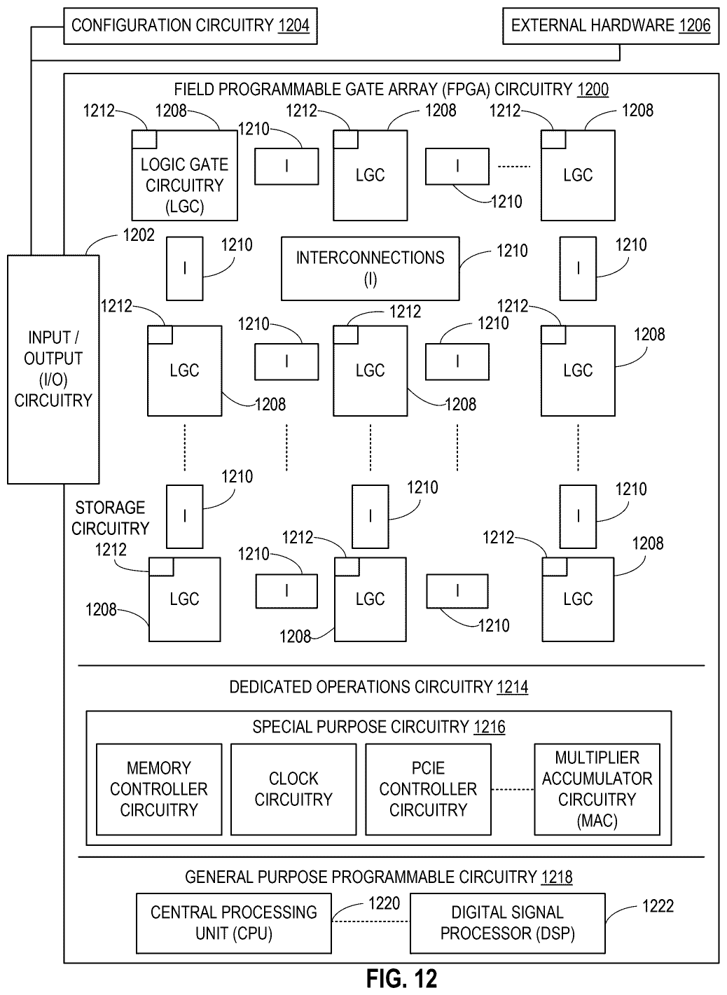

In some examples, the Near-RT RIC circuitry 108 includes means for determining a reward. For example, the means for determining a reward may be implemented by reward determiner circuitry 502. In some examples, the reward determiner circuitry 502 may be instantiated by programmable circuitry such as the example programmable circuitry 1012 of FIG. 10. For instance, the reward determiner circuitry 502 may be instantiated by the example microprocessor 1100 of FIG. 11 executing machine executable instructions such as those implemented by at least blocks 704 of FIG. 7. In some examples, the reward determiner circuitry 502 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the reward determiner circuitry 502 may be instantiated by any other combination of hardware, software, and/or firmware. For example, the reward determiner circuitry 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

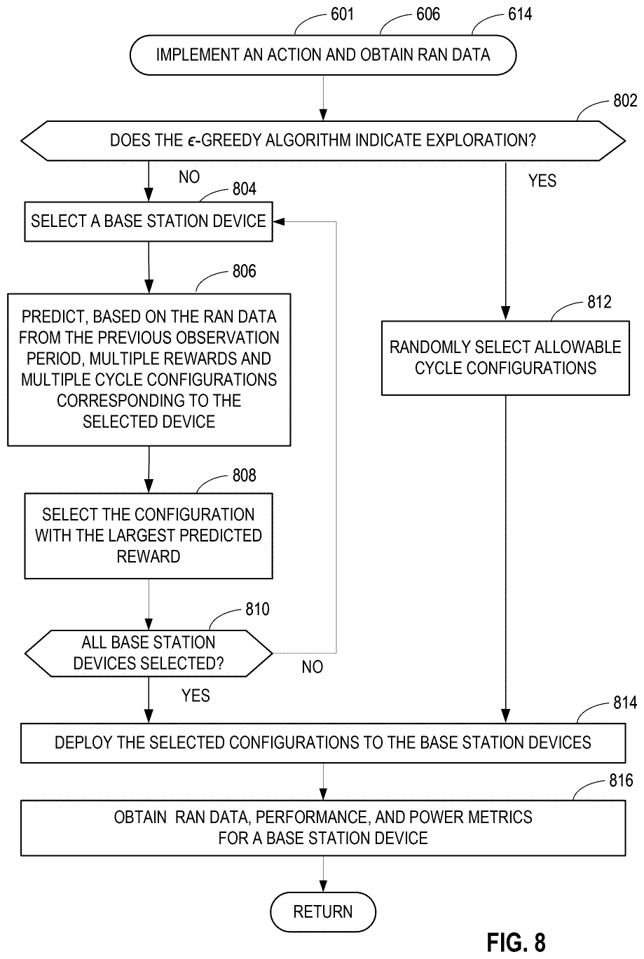

In some examples, the Near-RT RIC circuitry 108 includes means for determining cycle configurations. For example, the means for implementing cycle configurations may be implemented by AI agent circuitry 504. In some examples, the AI agent circuitry 504 may be instantiated by programmable circuitry such as the example programmable circuitry 1012 of FIG. 10. For instance, the AI agent circuitry 504 may be instantiated by the example microprocessor 1100 of FIG. 11 executing machine executable instructions such as those implemented by at least blocks 604, 802-804, 808-812 of FIGS. 6, 8. In some examples, the AI agent circuitry 504 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the AI agent circuitry 504 may be instantiated by any other combination of hardware, software, and/or firmware. For example, the AI agent circuitry 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Within the AI agent circuitry 504, the Q-network circuitry 506 is a fully connected multi-layer neural network that takes in the RAN observations 110 for each of the base station devices 104 and outputs a predicted reward for each action (e.g., each cycle configuration) possible under the input state. In this example, the number of nodes in the input layer of the Q-network circuitry 506 is the same as the number of RAN observation variables.

In some examples, the Q-network circuitry 506 includes one or more hidden layers between the input layer and the output layer. A given hidden layer node forms a linear combination from the output of the previous layer and applies a ReLU (rectified linear unit) activation function to said output. The ReLU converts any negative results that may be present to zero. The outputs of all nodes are then sent to the next layer. The hidden layer(s) may have different sizes (e.g., a different number of nodes) from the input layer, the output layer, and/or one another. In this example, the Q-network circuitry 506 includes two layers that both have 128 nodes.

The number of nodes in the output layer of the Q-network circuitry 506 is the number of possible actions (e.g., the number of cycle configurations 112). The cycle configurations 112 describe the total length of the BS-DTX/DRX cycle 200 (which may also be referred to herein as cycle-length), the duration of the active period 202 (which may also be referred to herein as on-duration), and the duration of the nonactive period 204 (which may also be referred to herein as off-duration) as described above. In this examples, the Q-network circuitry 506 does not generate the duration of the nonactive period 204 as a separate parameter because the base station devices 104 can determine such information from the other two parameters (e.g., cycle-length=on-duration+off-duration). Thus, a given output node in the Q-network circuitry 506 corresponds to a pair of parameters, cycle-length and on-duration. The pairs may take any of the finite values allowed in the 3GPP standard. The value within a given output node is a prediction of the reward that would be generated if the action described by the output node is implemented (e.g., if the base station device 104-1 performs BS-DTX/DRX cycles 200 using the cycle-length and on-duration parameters).

In addition to the on-duration and the off-duration described above, the cycle configurations 112 also include a start-offset value. The start-offset value indicates an amount of time a given base station device 104-1 should wait before starting a new BS-DTX/DRX cycle 200 with the cycle length and on-duration parameters received from the Near-RT RIC circuitry 108. In general, the Near-RT RIC circuitry 108 seeks to avoid multiple base station devices 104 deploying new cycle configurations 112 at the same time because if such concurrent configuration deployment does occur, many of the base station devices 104 would start operating in the active period 202 at the same time. This simultaneous transmission would increase inter-cell interference and degrade system performance. Instead the Near-RT RIC circuitry 108 assigns random start-offset values to cycle configurations that are produced in a group by the Q-network circuitry 506, thereby staggering the active periods 202 and decreasing inter-cell interference. In some examples, the Q-network circuitry 506 is instantiated by programmable circuitry executing Q-network instructions and/or configured to perform operations such as those represented by the flowchart(s) of FIGS. 6-9. Thus, an AI agent that outputs on-duration and cycle-length values together with a random start-offset value to define a BS-DTX/DRX cycle 200 may be implemented by one or more of the examples disclosed herein. In some examples, one or more of the values described above or herein as random are generated using pseudo-random techniques.

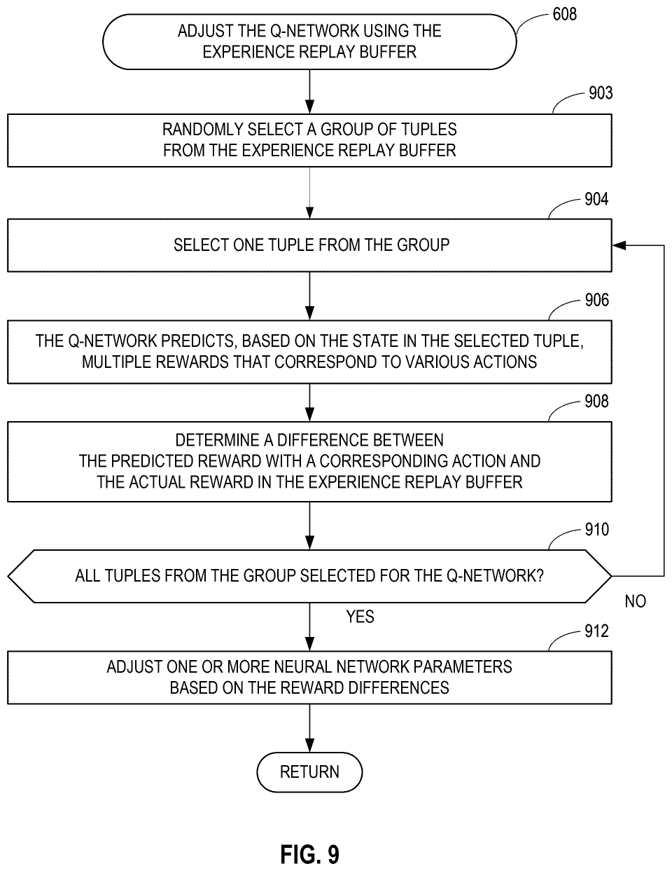

In some examples, the Near-RT RIC circuitry 108 includes means for determining cycle configurations. For example, the means for determining cycle configurations may be implemented by Q-network circuitry 506. In some examples, the Q-network circuitry 506 may be instantiated by programmable circuitry such as the example programmable circuitry 1012 of FIG. 10. For instance, the Q-network circuitry 506 may be instantiated by the example microprocessor 1100 of FIG. 11 executing machine executable instructions such as those implemented by at least blocks 806, 906 of FIGS. 8, 9. In some examples, the Q-network circuitry 506 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the Q-network circuitry 506 may be instantiated by any other combination of hardware, software, and/or firmware. For example, the Q-network circuitry 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The BS-DTX/DRX cycle described in the 3GPP standard also include a slot-offset parameter (in addition to the cycle-length and on-duration parameters described above). In the examples disclosed herein, slot-offset=0 so that the start of a new BS-DTX/DRX cycle 200 also corresponds to the start of a new active period 202 as shown in FIG. 2. In other examples, slot-offset is a nonzero and positive value. In such other examples, a BS-DTX/DRX cycle starts in a first nonactive period from t=0 to t=slot-offset, then has an active period from t=slot-offset to t=(slot-offset+on-duration), then ends with a second nonactive period from t=(slot-offset+on-duration) to t=cycle-length.

Within the AI agent circuitry 504, the experience replay buffer 508 stores (state, action, reward) tuples. Here, state refers to one or more RAN observations 110 that describe the traffic information and RAN transmission conditions of a base station device 104-1, action refers to a cycle configuration 112-1 that was implemented by the base station device 104-1 to produce the measurements in state, and reward refers to the value generated by the reward determiner circuitry 502 (e.g., a quantification of how well state balances energy savings and QoS performance). The experience replay buffer 508 is therefore populated during training mode by a) RAN observations 110, b) the reward determiner circuitry 502, and c) the Q-network circuitry 506. In some examples, a tuple stored in the experience replay buffer 508 is referred to as an experience. The experiences within the experience replay buffer 508 are used to train the Q-network circuitry 506 as described further in connection with FIG. 8.

The experience replay buffer 508 is implemented by any memory, storage device and/or storage disc for storing data such as, for example, flash memory, magnetic media, optical media, solid state memory, hard drive(s), thumb drive(s), etc. Furthermore, the data stored in the experience replay buffer 508 may be in any data format such as, for example, binary data, comma delimited data, tab delimited data, structured query language (SQL) structures, etc. While, in the illustrated example, the experience replay buffer 508 is illustrated as a single device, the experience replay buffer 508 and/or any other data storage devices disclosed herein may be implemented by any number and/or type(s) of memories.

In some examples, the Near-RT RIC circuitry 108 includes means for storing data (which may also be referred to as storage means). For example, the storage means may be implemented by experience replay buffer 508. In some examples, the experience replay buffer 508 may be instantiated by programmable circuitry such as the example programmable circuitry 1012 of FIG. 10. For instance, the experience replay buffer 508 may be instantiated by the example microprocessor 1100 of FIG. 11 executing machine executable instructions such as those implemented by at least blocks 602, 702, 706-710, 802, 803 of FIGS. 6-8. In some examples, the experience replay buffer 508 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the experience replay buffer 508 may be instantiated by any other combination of hardware, software, and/or firmware. For example, the experience replay buffer 508 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the Near-RT RIC circuitry 108 of FIG. 1 is illustrated in FIG. 5, one or more of the elements, processes, and/or devices illustrated in FIG. 5 may be combined, divided, re-arranged, omitted, eliminated, and/or implemented in any other way. Further, the example reward determiner circuitry 502, example AI agent circuitry 504, example Q-network circuitry 506, example experience replay buffer 508, and/or, more generally, the example Near-RT RIC circuitry 108 of FIG. 5, may be implemented by hardware alone or by hardware in combination with software and/or firmware. Thus, for example, any of the example reward determiner circuitry 502, example AI agent circuitry 504, example Q-network circuitry 506, example experience replay buffer 508, and/or, more generally, the example Near-RT RIC circuitry 108, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example Near-RT RIC circuitry 108 of FIG. 5 may include one or more elements, processes, and/or devices in addition to, or instead of, those illustrated in FIG. 5, and/or may include more than one of any or all of the illustrated elements, processes and devices.

Flowchart(s) representative of example machine-readable instructions, which may be executed by programmable circuitry to implement and/or instantiate the Near-RT RIC circuitry 108 of FIG. 5 and/or representative of example operations which may be performed by programmable circuitry to implement and/or instantiate the Near-RT RIC circuitry 108 of FIG. 5, are shown in FIGS. 6-9. The machine-readable instructions may be one or more executable programs or portion(s) of one or more executable programs for execution by programmable circuitry such as the programmable circuitry 1012 shown in the example programmable circuitry platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-9, many other methods of implementing the example Near-RT RIC circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions disclosed herein may be stored in one or more of a compressed format, an encrypted format, a fragmented format, a compiled format, an executable format, a packaged format, etc. Machine readable instructions as disclosed herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that disclosed herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions disclosed herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6-9 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by programmable circuitry to implement the Near-RT RIC circuitry 108. The example machine-readable instructions and/or the example operations 600 of FIG. 3 begin in pre-training mode when the Near-RT RIC circuitry 108 implements an action and obtains RAN data. (Block 601). To do so, the Near-RT RIC circuitry 108 both a) implements the action based on RAN data from a previous observation period and b) obtains additional RAN data during a new (e.g. the current) observation period. The base station devices 104 record new RAN measurements during each observation period as described above. In general, observation periods may occur at any periodic or aperiodic basis. In the example of FIG. 6, an observation period occurs whenever block 601, 606, or 614 is implemented. The Near-RT RIC circuitry 108 implements an action by providing a cycle configuration (e.g., 112-1) to a corresponding base station device (e.g., 104-1). Block 601 is described further in connection with FIG. 8.

The Near-RT RIC circuitry 108 adds an entry to the experience replay buffer 508. (Block 602). The entry of block 602 is a data structure (e.g., a tuple) that describes a) a previous action implemented by the AI agent circuitry 504 during training, b) the network conditions of the RAN during the observation period preceding said action, and c) a reward value based on the network conditions of the RAN during one or more observation periods that occur after the action is implemented. Tuples and block 602 are described further in connection with FIG. 7.

The Near-RT RIC circuitry 108 determines whether the number of entries stored in the experience replay buffer 508 satisfy a threshold. (Block 604). In this example, the threshold of block 604 if the number of tuples stored in the experience replay buffer 508 is greater than or equal to a threshold value. If the number of entries stored in the experience replay buffer 508 fail to satisfy the threshold (Block 604: No), control returns to block 602 where the Near-RT RIC circuitry 108 populates the experience replay buffer 508 with another tuple. In some examples, blocks 601-604 are collectively referred to as pre-training mode.

If the number of entries in the experience replay buffer 508 does satisfy the threshold (Block 604: Yes), the Near-RT RIC circuitry 108 forms normalization coefficients based on values in the experience replay buffer 508. (Block 605). In this example, the Near-RT RIC circuitry 108 implements block 605 by identifying maximum values within the RAN observations of the tuples and then dividing each RAN variable by its corresponding maximum value. The normalization coefficients are present within the first layer of the Q-network (e.g., before the fully connected layers) and are therefore used whenever the AI model is executed (e.g., at blocks 601, 606, 608, and 614 in FIG. 6). In iterations of block 601 (e.g., during pre-training), the normalization coefficients may include random or initial values because the Near-RT RIC circuitry 108 has not yet executed block 605. In other examples, the Near-RT RIC circuitry 108 performs different normalization operations.

The Near-RT RIC circuitry 108 enters training mode, implements an action, and obtains RAN data. (Block 606). Thus, like block 601, the Near-RT RIC circuitry 108 implements block 606 by both utilizing data from a previous observation period and obtaining data from the current observation period at block 606. In this example, the Near-RT RIC circuitry 108 in FIG. 6 performs one training step (one iteration of blocks 606-609) per observation period when in training mode. Accordingly, the Near-RT RIC circuitry 108 makes the decision of which action to implement at block 606 in view of the most recent set of relevant RAN measurements. Like block 601, block 606 is described further in connection with FIG. 8.

The AI agent circuitry 504 adjusts the machine learning model implemented by the Q-network circuitry 506 using the experience replay buffer 508. (Block 608). The adjustments to the machine learning model are based on a comparison of the output of the Q-network circuitry 506 and the values in the experience replay buffer 508. Block 608 is described further in connection with FIG. 9.

The AI agent circuitry 504 adds an entry to the experience replay buffer. (Block 609). During block 609, a new observation period occurs in which new RAN measurements are recorded. The new RAN measurements reflect the effect of the implemented action from block 606, thereby allowing the AI agent circuitry 504 to learn (in a subsequent training step) from its previous actions. Blocks 602 and 609 are both described further in connection with FIG. 7.

Execution of blocks 606-609 may be collectively referred to as performance of a training step. Accordingly, after block 609, the Near-RT RIC circuitry 108 determines whether to implement another training step. (Block 610). In this example, the Near-RT RIC circuitry 108 continues to perform another training step (Block 610: Yes) until a predetermined number of training steps (e.g., 5,000) have been executed. In other examples, the Near-RT RIC circuitry 108 continues to perform another training step (Block 610: Yes) until the amount or size of adjustments performed at block 606 is sufficiently minimal (e.g., the amount or size of adjustments is less than a threshold metric).

If the Near-RT RIC circuitry 108 decides to perform another training step (Block 610: Yes), control returns to block 606 where the Near-RT RIC circuitry 108 implements an action based on RAN data from the previous observation period. In this iteration of block 606, the previous observation period refers to the observation period from the previous iteration of block 609.

Alternatively, if the Near-RT RIC circuitry 108 stops performing training steps (Block 610: No), training mode is considered complete and inference mode begins. In inference mode, the Near-RT RIC circuitry 108 implements an action and obtains RAN data. (Block 614). Like blocks 601 and 606, block 614 is also described further in connection with FIG. 8. The implemented action at block 614 (e.g., during inference mode) is at or near the improved cycle configuration as described in FIG. 4, but actions implemented at block 601 and 606 may be comparatively inaccurate (e.g., during pre-training and training mode).

The Near-RT RIC circuitry 108 determines whether to continue in inference mode. (Block 616). In some examples, the Near-RT RIC circuitry 108 continues in inference mode for as long as the device has power because the best balance between delay-sensitive QoS traffic requirements and energy savings is continuously changing based on real-time changes in RAN conditions.

If the Near-RT RIC circuitry 108 decides to continue in inference mode (Block 616: Yes), control returns to block 614 where the Near-RT RIC circuitry 108 obtains new RAN data. The machine-readable instructions and/or operations 600 end if the Near-RT RIC circuitry 108 does not continue in inference mode (Block 616: No).

FIG. 6 shows that the Near-RT RIC circuitry 108 uses similar operations to implement actions during both inference mode and training mode. FIG. 6 also shows that training mode additionally includes intermediate operations (e.g., adjusting the model at block 608 and adding an entry to the experience replay buffer 508 at block 609) between implemented actions. In some examples, the Near-RT RIC circuitry 108 returns to training mode after spending an amount of time in inference mode. The Near-RT RIC circuitry 108 may return to training mode for any reason, including but not limited to a response to a certain network conditions, the passage of a threshold amount of time, etc. In some examples, a return to training mode may be referred to as model tuning.

FIG. 7 is a flowchart representative of example machine-readable instructions and/or example operations that may be executed, instantiated, and/or performed by example programmable circuitry to add an entry to the experience replay buffer as described in FIG. 6. In particular, FIG. 7 is an example implementation of blocks 602 and 609 of FIG. 6.

Execution of blocks 602 and 609 begin when the reward determiner circuitry 502 calculates a reward based on measurements that include performance and power metrics. (Block 704). The metrics refer to the RAN data from the most recent observation period (e.g., data obtained during blocks 601 or 606). The reward quantifies how well the base station device 104-1 is currently balancing QoS performance and energy savings. The reward determiner circuitry 502 may use any of the techniques described above in connection with FIG. 5 to determine a reward value.

The Near-RT RIC circuitry 108 determines whether the experience replay buffer 508 is full. (Block 706). The experience replay buffer 508 is implemented by memory within the Near-RT RIC circuitry 108 and therefore stores a finite amount of data. If the experience replay buffer is full (Block 706: Yes), the Near-RT RIC circuitry 108 removes the oldest tuple from the experience replay buffer 508. (Block 708).

After block 708, or if the experience replay buffer is not full (Block 706: No), the Near-RT RIC circuitry 108 adds a (state, action, reward) tuple to the experience replay buffer 508. (Block 710). Here, state refers to RAN data that describes the conditions of the network before the current configuration was deployed. Thus, state includes RAN data from the previous observation period (e.g., data not from the most recent iteration of block 816 of FIG. 8, but from the iteration of block 816 that preceded the most recent iteration). Next, action refers to the current configuration (e.g., the current BS-DTX/DRX cycle parameters) of the base station device. As described further below, the current configuration is deployed at the most recent iteration of block 814 of FIG. 8. Finally, reward refers to the value calculated at block 704. By replacing old tuples from the experience replay buffer 508 with new tuples when necessary (e.g., at block 708), the Near-RT RIC circuitry 108 ensures that adjustments to the DQN machine learning model at block 608 are made based on recent training steps and not outdated training steps (which generally reflect the state of the RAN when the model was less accurate). The machine-readable instructions and/or operations 600 return to blocks 604 or 610 after blocks 602 or 609, respectively.

FIG. 8 is a flowchart representative of example machine-readable instructions and/or example operations that may be executed, instantiated, and/or performed by example programmable circuitry to implement an action and obtain RAN data as described in FIG. 6. In particular, FIG. 8 is an example implementation of blocks 601, 606, and block 614 of FIG. 6.

Execution of blocks 601, 606, and 614 begin when the AI agent circuitry 504 determines whether the epsilon-greedy algorithm indicates exploration. In this example, epsilon (the name of the Greek letter E) is a value between 1 and 0 that gradually decreases throughout the pre-training mode and training mode (e.g., during subsequent iterations of blocks 601 and 606). At any given training step, the epsilon-greedy algorithm indicates exploration (Block 802: Yes) with probability e. Similarly, at any given training step, the epsilon-greedy algorithm does not indicate exploration (Block 802: No) with probability (1−ϵ). During inference mode (e.g. at block 614), ϵ=0 and the epsilon-greedy algorithm does not indicate exploration (Block 802: No).

If the epsilon-greedy algorithm does not indicate exploration (Block 802: No), the AI agent circuitry 504 selects a base station device from those that are described within the relevant RAN data. (Block 804). In each of pre-training mode (e.g., block 601), training mode (e.g., block 606) and inference mode (e.g., block 614), the relevant RAN data of block 804 refers to measurements from the previous observation period as described above.

The Q-network circuitry 506 predicts, based on the RAN data from the previous observation period, multiple rewards and multiple cycle configurations corresponding to the selected base station device. (Block 806). In this example, each of the cycle configurations 112 may include nonzero values for cycle-length (e.g., the total duration of the BS-DTX/DRX cycle 200), and on-duration value (e.g., the duration of the active period), and a start-offset value as described above. The cycle configurations 112 do not contain a separate slot-offset value in these examples because slot-offset is presumed to be 0. In other examples, slot-offset may have nonzero values and is therefore included in the cycle configurations 112. The Q-network circuitry 506 also predicts respective rewards for the respective cycle configurations (e.g., one reward per configuration) generated at block 806. Whereas the inputs to the Q-network circuitry 506 are tuples from the experience replay buffer 508 when adjusting the AI model (e.g. at block 608), the inputs to the Q-network circuitry 506 here at block 806 is the RAN data from the previous observation period as described above.

The Q-network circuitry 506 selects the cycle configuration with the largest predicted reward value. (Block 808). The reward determiner circuitry 502 generates reward values in which a larger reward value indicates the machine learning model is more accurate (and therefore closer to the improved cycle configuration) than a smaller reward value. Accordingly, the Q-network circuitry 506 selects the cycle configuration it has predicted to be the most successful at block 808 by selecting the configuration that corresponds to the largest predicted reward.

The AI agent circuitry 504 determines whether all base station devices described within the RAN data have been selected. (Block 810). If all base station devices have not been selected (Block 810: No), control returns to block 804 where the AI agent circuitry 504 selects another base station device whose corresponding RAN data has not been used as an input to the Q-network machine learning model.

Alternatively, if the epsilon-greedy algorithm does indicate exploration (Block 802: Yes), the AI agent circuitry 504 randomly selects allowable cycle configurations. (Block 812). To do so, the AI agent circuitry 504 forms an allowable configuration based on random durations of the active period and the nonactive period. A cycle configuration 112-1 is allowable if it can be implemented by a base station device 104-1 (e.g., if cycle-length is greater than any predetermined minimums set by the 3GPP standard and less than any predetermined maximums set by the 3GPP standard, if on-duration is less than or equal to cycle-length, etc.).

After either of block 810 or block 812, the Near-RT RIC circuitry 108 deploys the selected cycle configurations to the base station devices 104. (Block 814). In some examples, deploying cycle configurations is referred to as implementing actions as described above.

The epsilon-greedy algorithm of block 802 enables training of the machine learning model implemented by the Q-network circuitry 506 in a contextual multi-arm bandit framework. In general, the contextual multi-arm bandit framework refers to a model training technique where an algorithm chooses between multiple options (arms) to maximize its reward, with each choice informed by the current context or situation. The algorithm learns over time which arm is likely to yield the best outcome based on the context, improving its decisions through a balance of exploring new options and exploiting known rewarding options. For example, randomization is especially relevant during the initial training steps when significant adjustments have not yet been made to the various internal parameters of the machine learning model. During such time, accuracy of the predictions at block 806 is relatively low and performance improvements are more likely to occur by trying new model parameters rather than tweaking existing model parameters. Randomly selecting configurations at block 812 increases the probability of larger changes in model parameters during a subsequent training step (e.g., at a subsequent iteration of block 812). Such large changes can generally be considered as trying new model parameters rather than tweaking existing parameters as described above.

The Near-RT RIC circuitry 108 obtains RAN data, performance metrics, and power metrics for a base station device. (Block 816). The data for block 816 characterizes how the RAN changes based on the deployed configurations of block 814. The RAN data is recorded by the base station device (e.g., 104-1) during an observation period. As described above, observation periods may generally occur with any periodic or aperiodic timing and there is one observation period per training step while in training mode. The machine-readable instructions and/or operations 600 return to blocks 602, 608, or 616 after block 816.

FIG. 9 is a flowchart representative of example machine-readable instructions and/or example operations that may be executed, instantiated, and/or performed by example programmable circuitry to adjust the Q-network using the experience replay buffer as described in FIG. 7. FIG. 9 is an example implementation of block 608 of FIG. 6.

Execution of block 608 begins when the AI agent circuitry 504 randomly selects a group of tuples from the experience replay buffer 508. (Block 903). The size of the group may be any size (e.g., 128). In some examples, the group of block 903 is referred to as a batch or a subset.

The AI agent circuitry 504 selects one tuple from the group. (Block 904). The Q-network circuitry 506 then predicts, based on the state within the selected tuple, multiple rewards that correspond to various actions. (Block 906). In this example, each output node of the AI model has a fixed and unique association to an action. For example, a first output node correspond a first cycle configuration, a second output node corresponds to a second cycle configuration different than the first, etc. The Q-network circuitry 506 generates at each output node a prediction of what reward would be produced by the reward determiner circuitry 502 if the cycle configuration associated with said output node was deployed to the base station device 104-1 (e.g., if the action was implemented).

The AI agent circuitry 504 determines a difference between a) the predicted reward at block 906 whose associated cycle configuration matches the cycle configuration stored in the selected tuple and b) and the actual reward value stored in the selected tuple. (Block 908). In this example, the actual reward value refers to the determined reward value of block 704. The difference of block 908 is, in general, inversely proportional to the accuracy of the machine learning model implemented by the Q-network circuitry 506. For example, a small difference value indicates the model is comparatively accurate and a large difference value indicates the model is comparatively inaccurate.

The AI agent circuitry 504 determines whether all the tuples from the group have been selected for the Q-network. (Block 910). If all the tuples from the group have not been selected for the Q-network (Block 910: No), control returns to block 904 where the AI agent circuitry 504 selects another tuple from the group that has not yet been provided to the Q-network circuitry 506 as an input. Alternatively, if the all the tuples from the group have been selected for the Q-network (Block 910: Yes), the AI agent circuitry 504 adjusts one or more neural network parameters based on the reward differences. (Block 912). Such neural network parameters may include but are not limited to embeddings, weights, activation functions, etc. In some examples, the adjustments of block 912 are referred to as model training and/or model retraining operations. Control returns to block 609 after block 912.

FIG. 10 is a block diagram of an example programmable circuitry platform 1000 structured to execute and/or instantiate the example machine-readable instructions and/or the example operations of FIGS. 6-9 to implement the Near-RT RIC circuitry 108 of FIG. 5. The programmable circuitry platform 1000 can be, for example, a server, a personal computer, a workstation, a self-learning machine (e.g., a neural network), an Internet appliance, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. The programmable circuitry 1012 may be implemented by one or more semiconductor based (e.g., silicon based) devices. In this example, the programmable circuitry 1012 implements the reward determiner circuitry 502, the AI agent circuitry 504, and the Q-network circuitry 506.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016. In this example, the main memory 1014, 1016 implements the experience replay buffer 508.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU. In this example, the input devices 1022 and the output devices 1024 both include the base station devices 104.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIGS. 6-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 6-9 to effectively instantiate the circuitry of FIG. 5 as logic circuits to perform operations corresponding to those machine-readable instructions. In some such examples, the circuitry of FIG. 5 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion, or all of the machine-readable instructions and/or operations represented by the flowcharts of FIGS. 6-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 6-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-9. As such, the FPGA circuitry 1200 may be configured and/or structured to effectively instantiate some or all of the operations/functions corresponding to the machine-readable instructions of the flowchart(s) of FIGS. 6-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 6-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 6-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 6-9 to perform first operation(s)/function(s), the FPGA circuitry 1200 of FIG. 12 may be configured and/or structured to perform second operation(s)/function(s) corresponding to a second portion of the machine-readable instructions represented by the flowcharts of FIGS. 6-9, and/or an ASIC may be configured and/or structured to perform third operation(s)/function(s) corresponding to a third portion of the machine-readable instructions represented by the flowcharts of FIGS. 6-9.

It should be understood that some or all of the circuitry of FIG. 5 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 5 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

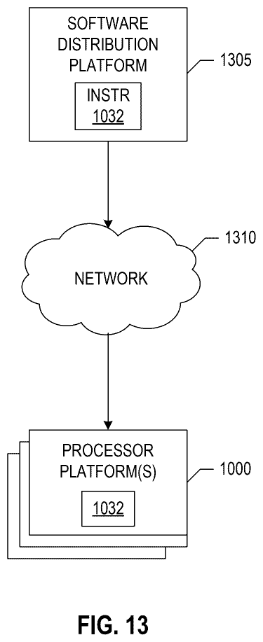

A block diagram illustrating an example software distribution platform 1305 to distribute software such as the example machine-readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine-readable instructions of FIGS. 6-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1032 from the software distribution platform 1305. For example, the software, which may correspond to the example machine-readable instructions of FIGS. 6-9, may be downloaded to the example programmable circuitry platform 1000, which is to execute the machine-readable instructions 1032 to implement the Near-RT RIC circuitry 108. In some examples, one or more servers of the software distribution platform 1305 periodically offer, transmit, and/or force updates to the software (e.g., the example machine-readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that leverage AU to control the BS-DTX/DRX cycle to improve (e.g., maximize) the energy savings of a base station device while satisfying delay sensitive traffic QoS requirements. Disclosed systems, apparatus, articles of manufacture, and methods improve the efficiency of a computing device. In some examples, a reward value is determined for a given BS-DTX/DRX configuration based on the performance and power metrics of a base station device and using a linear function, a QoS threshold function, and/or a smooth approximation of the QoS threshold function. In some examples, a machine learning model is trained using Reinforcement Learning techniques (e.g., a contextual multi-armed bandit agent and a Deep-Q Network) based on RAN data about a base station device. The cycle configuration identified by the trained model is the output of the AI model and the BS-DTX/DRX cycle with the largest predicted reward value. Disclosed systems, apparatus, articles of manufacture, and methods are accordingly directed to one or more improvement(s) in the operation of a machine such as a cell tower and/or one or more compute devices within a cell tower (e.g., a base station device).

Example methods, apparatus, systems, and articles of manufacture to determine sleep modes are disclosed herein. Further examples and combinations thereof include the following:

Example 1 includes an apparatus comprising interface circuitry, machine-readable instructions, and at least one programmable circuit to be programmed by the machine-readable instructions to execute a machine learning model based on performance data corresponding to a base station device to determine a configuration that includes at least one of a duration of an active period or a duration of a nonactive period, the base station device to be at full power during the active period and to be in a sleep mode during the nonactive period, and deploy the configuration to the base station device.

Example 2 includes the apparatus of example 1, wherein the machine learning model includes at least one of a contextual multi-armed bandit agent or a deep-q neural network.

Example 3 includes the apparatus of one or more of examples 1-2, wherein one or more of the at least one programmable circuit is to increase the duration of the nonactive period to satisfy a quality of service (QOS) threshold.

Example 4 includes the apparatus of one or more of examples 1-3, wherein the base station device includes a memory buffer, the base station device is to remove data transmitted by the base station device from the memory buffer and to add data received by the base station device to the memory buffer, and one or more of the at least one programmable circuit is to determine satisfaction of the QoS threshold with respect to the configuration based on an overflow status of the memory buffer.

Example 5 includes the apparatus of one or more of examples 1-4, wherein a rate at which the cell tower is to transmit data is based on the duration of the active period and controllable by one or more of the at least one programmable circuit, and a rate at which the cell tower is to receive data is based on end user equipment.

Example 6 includes the apparatus of one or more of examples 1-5, wherein the one or more parameters include one or more of cell tower traffic intensity statistics, inter-arrival time statistics, packet size statistics, traffic delay requirements, or cell tower transmission capability statistics.

Example 7 includes the apparatus of one or more of examples 1-6, wherein one or more of the at least one programmable circuit is to determine a reward based on measurements of one or more performance and power metrics of the cell tower after the deployment.

Example 8 includes the apparatus of one or more of examples 1-7, wherein one or more of the at least one programmable circuit is to determine the reward based on at least one of a linear function, a discontinuous quality of service (QOS) threshold function, or a smooth approximation of the discontinuous QoS threshold function.

Example 9 includes the apparatus of one or more of examples 1-8, wherein to select the configuration from a plurality of configurations, the machine learning model is to predict respective rewards for the configurations, and select the configuration which corresponds to a largest predicted reward in the plurality.

Example 10 includes the apparatus of one or more of examples 1-9, wherein the at least one programmable circuit is to predict, with the machine learning model, a reward for the configuration, and adjust the machine learning model based on a difference between the predicted reward for the selected configuration and the determined reward.

Example 11 includes the apparatus of one or more of examples 1-10, wherein one or more of the at least one programmable circuit is to form a configuration based on random durations of the active period and the nonactive period.

Example 12 includes at least one non-transitory machine-readable storage medium comprising instructions to cause at least one programmable circuit to at least execute a machine learning model based on one or more parameters corresponding to a performance of a cell tower to determine a configuration for the cell tower, the configuration to include at least one of a duration of an active period or a duration of a nonactive period, the cell tower to be at full power during the active period and to be in a sleep mode during the nonactive period, and deploy the configuration to the cell tower.

Example 13 includes the at least one non-transitory machine-readable storage medium of example 12, wherein the machine learning model includes a contextual multi-armed bandit agent or a deep-q neural network.

Example 14 includes the at least one non-transitory machine-readable storage medium of one or more of examples 12-13, wherein one or more of the at least one programmable circuit is to increase the duration of the nonactive period and satisfy a quality of service (QOS) threshold by deploying the configuration.

Example 15 includes the at least one non-transitory machine-readable storage medium of one or more of examples 12-14, wherein the cell tower includes a memory buffer, the cell tower is to remove data transmitted by the cell tower from the memory buffer and to add data received by the cell tower to the memory buffer, and one or more of the at least one programmable circuit is to determine satisfaction of the QoS threshold with respect to the configuration based on an overflow status of the memory buffer.

Example 16 includes the at least one non-transitory machine-readable storage medium of one or more of examples 12-15, wherein a rate at which the cell tower is to transmit data is based on the duration of the active period and controllable by one or more of the at least one programmable circuit, and a rate at which the cell tower is to receive data is based on end user equipment.

Example 17 includes the at least one non-transitory machine-readable storage medium of one or more of examples 12-16, wherein the one or more parameters include one or more of cell tower traffic intensity statistics, inter-arrival time statistics, packet size statistics, traffic delay requirements, or cell tower transmission capability statistics.

Example 18 includes the at least one non-transitory machine-readable storage medium of one or more of examples 12-17, wherein one or more of the at least one programmable circuit is to determine a reward based on measurements of one or more performance and power metrics of the cell tower after the deployment.

Example 19 includes the at least one non-transitory machine-readable storage medium of one or more of examples 12-18, wherein one or more of the at least one programmable circuit is to determine the reward based on at least one of a linear function, a discontinuous quality of service (QOS) threshold function, or a smooth approximation of the discontinuous QoS threshold function.

Example 20 includes the at least one non-transitory machine-readable storage medium of one or more of examples 12-19, wherein to select the configuration from a plurality of configurations, the machine learning model is to predict respective rewards for the configurations, and select the configuration which corresponds to a largest predicted reward in the plurality.

Example 21 includes the at least one non-transitory machine-readable storage medium of one or more of examples 12-20, wherein the at least one programmable circuit is to predict, with the machine learning model, a reward for the configuration, and adjust the machine learning model based on a difference between the predicted reward for the selected configuration and the determined reward.

Example 22 includes the at least one non-transitory machine-readable storage medium of one or more of examples 12-21, wherein one or more of the at least one programmable circuit is to form a configuration based on random durations of the active period and the nonactive period.

Example 23 includes an apparatus comprising means for determining cycle configurations to execute a machine learning model based on one or more parameters corresponding to a performance of a cell tower to determine a configuration for the cell tower, the configuration to include at least one of a duration of an active period or a duration of a nonactive period, the cell tower to be at full power during the active period and to be in a sleep mode during the nonactive period, and means for implementing cycle configurations to deploy the configuration to the cell tower.

Example 24 includes the apparatus of example 23, wherein the means for determining cycle configurations implements a contextual multi-armed bandit agent or a deep-q neural network.

Example 25 includes the apparatus of one or more of examples 23-24, wherein the means for determining cycle configurations is to increase the duration of the nonactive period and satisfy a quality of service (QOS) threshold by deploying the configuration.

Example 26 includes the apparatus of one or more of examples 23-25, wherein the cell tower includes a memory buffer, the cell tower is to remove data transmitted by the cell tower from the memory buffer and to add data received by the cell tower to the memory buffer, and the means for implementing cycle configurations is to determine satisfaction of the QoS threshold with respect to the configuration based on an overflow status of the memory buffer.

Example 27 includes the apparatus of one or more of examples 23-26, wherein a rate at which the cell tower is to transmit data is based on the duration of the active period and controllable by the means for determining cycle configurations, and a rate at which the cell tower is to receive data is based on end user equipment.

Example 28 includes the apparatus of one or more of examples 23-27, wherein the one or more parameters include one or more of cell tower traffic intensity statistics, inter-arrival time statistics, packet size statistics, traffic delay requirements, or cell tower transmission capability statistics.

Example 29 includes the apparatus of one or more of examples 23-28, further including means for determining a reward based on measurements of one or more performance and power metrics of the cell tower after the deployment.

Example 30 includes the apparatus of one or more of examples 23-29, wherein the means for determining the reward is to determine the reward based on at least one of a linear function, a discontinuous quality of service (QOS) threshold function, or a smooth approximation of the discontinuous QoS threshold function.

Example 31 includes the apparatus of one or more of examples 23-30, wherein to select the configuration from a plurality of configurations, the means for determining configurations is to predict respective rewards for the configurations, and select the configuration which corresponds to a largest predicted reward in the plurality.

Example 32 includes the apparatus of one or more of examples 23-31, wherein the means for determining cycle configurations is to predict, with the machine learning model, a reward for the configuration, and the means for implementing cycle configurations is to adjust the machine learning model based on a difference between the predicted reward for the selected configuration and the determined reward.

Example 33 includes the apparatus of one or more of examples 23-32, wherein the means for implementing cycle configurations is to form a configuration based on random durations of the active period and the nonactive period.

Example 34 includes a method comprising executing a machine learning model with at least one programmable circuit based on one or more parameters corresponding to a performance of a cell tower to determine a configuration for the cell tower, the configuration to include at least one of a duration of an active period or a duration of a nonactive period, the cell tower to be at full power during the active period and to be in a sleep mode during the nonactive period, and deploying the configuration to the cell tower.

Example 35 includes the method of example 34, including implementing the machine learning model as a contextual multi-armed bandit agent or a deep-q neural network.

Example 36 includes the method of one or more of examples 34-35, including increasing the duration of the nonactive period and satisfy a quality of service (QOS) threshold by deploying the configuration.

Example 37 includes the method of one or more of examples 34-36, wherein the cell tower includes a memory buffer, the cell tower is to remove data transmitted by the cell tower from the memory buffer and to add data received by the cell tower to the memory buffer, and the method includes determining satisfaction of the QoS threshold with respect to the configuration based on an overflow status of the memory buffer.

Example 38 includes the method of one or more of examples 34-37, wherein a rate at which the cell tower is to transmit data is based on the duration of the active period and controllable by the at least one or more programmable circuit, and a rate at which the cell tower is to receive data is based on end user equipment.

Example 39 includes the method of one or more of examples 34-38, wherein the one or more parameters include one or more of cell tower traffic intensity statistics, inter-arrival time statistics, packet size statistics, traffic delay requirements, or cell tower transmission capability statistics.

Example 40 includes the method of one or more of examples 34-39, including determining a reward based on measurements of one or more performance and power metrics of the cell tower after the deployment.

Example 41 includes the method of one or more of examples 34-40, including determining the reward based on at least one of a linear function, a discontinuous quality of service (QOS) threshold function, or a smooth approximation of the discontinuous QoS threshold function.

Example 42 includes the method of one or more of examples 34-41, including selecting, with the machine learning model, from a plurality of configurations by predicting respective rewards for the configurations, and selecting the configuration which corresponds to a largest predicted reward in the plurality.

Example 43 includes the method of one or more of examples 34-42, including retraining the machine learning model based on a difference between the predicted reward for the selected configuration and the determined reward.

Example 44 includes the method of one or more of examples 34-43, including forming a configuration based on random durations of the active period and nonactive period.

Example 45 includes an apparatus comprising E2 interface circuitry, machine-readable instructions, and at least one programmable circuit to be programmed by the machine-readable instructions to: periodically collect Radio Access Network (RAN) data from the E2 interface circuitry, execute an Artificial Intelligence (AI) model based on the RAN data, and output a configuration produced by the AI model that describes a discontinuous transmission/discontinuous reception (DTX/DRX) cycle of a base station device, the configuration to include a total duration of the DTX/DRX cycle, a duration of an active period within the DTX/DRX cycle, and a random start-offset value.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed by the machine-readable instructions to:
execute a machine learning model based on performance data corresponding to a base station device to determine a configuration that includes at least one of a duration of an active period or a duration of a nonactive period, the base station device to consume a first amount of power during the active period and a second amount of power during the nonactive period, the second amount less than the first amount; and
deploy the configuration to the base station device.

2. The apparatus of claim 1, wherein the machine learning model includes at least one of a contextual multi-armed bandit agent or a deep-q neural network.

3. The apparatus of claim 1, wherein one or more of the at least one programmable circuit is to increase the duration of the nonactive period and satisfy a quality of service (QOS) threshold.

4. The apparatus of claim 3, wherein:
the base station device includes a memory buffer, the base station device is to remove data transmitted by the base station device from the memory buffer and to add data received by the base station device to the memory buffer; and
one or more of the at least one programmable circuit is to determine satisfaction of the QoS threshold with respect to the configuration based on an overflow status of the memory buffer.

5. The apparatus of claim 4, wherein:
a rate at which the base station device is to transmit data is based on the duration of the active period; and
a rate at which the base station device is to receive data is based on end user equipment.

6. The apparatus of claim 1, wherein the performance data includes one or more of: cell tower traffic intensity statistics, inter-arrival time statistics, packet size statistics, traffic delay requirements, or cell tower transmission capability statistics.

7. The apparatus of claim 1, wherein one or more of the at least one programmable circuit is to determine a reward based on measurements of one or more performance and power metrics of the base station device after the deployment.

8. The apparatus of claim 7, wherein one or more of the at least one programmable circuit is to determine the reward based on at least one of: a linear function, a discontinuous quality of service (QOS) threshold function, or a smooth approximation of the discontinuous QoS threshold function.

9. The apparatus of claim 7, wherein to select a configuration for the base station device from a plurality of configurations, the machine learning model is to:
predict respective rewards for the configurations; and
select the configuration which corresponds to a largest predicted reward in the plurality.

10. The apparatus of claim 9, wherein one or more of the at least one programmable circuit is to retrain the machine learning model based on a difference between the predicted reward for the selected configuration and the determined reward.

11. The apparatus of claim 1, wherein one or more of the at least one programmable circuit is to generate a configuration based on random durations of the active period and the nonactive period.

12. At least one non-transitory machine-readable storage medium comprising instructions to cause at least one programmable circuit to at least:
execute a machine learning model based on performance data corresponding to a base station device to determine a configuration that includes at least one of a duration of an active period or a duration of a nonactive period, the base station device to consume a first amount of power during the active period and a second amount of power during the nonactive period, the second amount less than the first amount; and
deploy the configuration to the base station device.

13. The at least one non-transitory machine-readable storage medium of claim 12, wherein the machine learning model includes at least one of a contextual multi-armed bandit agent or a deep-q neural network.

14. The at least one non-transitory machine-readable storage medium of claim 12, wherein one or more of the at least one programmable circuit is to increase the duration of the nonactive period and satisfy a quality of service (QoS) threshold.

15. The at least one non-transitory machine-readable storage medium of claim 14, wherein:
the base station device includes a memory buffer, the base station device is to remove data transmitted by the base station device from the memory buffer and to add data received by the base station device to the memory buffer; and
one or more of the at least one programmable circuit is to determine satisfaction of the QoS threshold with respect to the configuration based on an overflow status of the memory buffer.

16. The at least one non-transitory machine-readable storage medium of claim 15, wherein:
a rate at which the base station device is to transmit data is based on the duration of the active period; and
a rate at which the base station device is to receive data is based on end user equipment.

17. The at least one non-transitory machine-readable storage medium of claim 12, wherein the performance data includes one or more of: base station device traffic intensity statistics, inter-arrival time statistics, packet size statistics, traffic delay requirements, or base station device transmission capability statistics.

18. The at least one non-transitory machine-readable storage medium of claim 12, wherein one or more of the at least one programmable circuit is to determine a reward based on measurements of one or more performance and power metrics of the base station device after the deployment.

19. An apparatus comprising:
means for determining cycle configurations to execute a machine learning model based on performance data corresponding to a base station device to determine a configuration that includes at least one of a duration of an active period or a duration of a nonactive period, the base station device to consume a first amount of power during the active period and a second amount of power during the nonactive period, the second amount less than the first amount; and
means for implementing cycle configurations to deploy the configuration to the base station device.

20. The apparatus of claim 19, wherein the means for determining cycle configurations is to increase the duration of the nonactive period and satisfy a quality of service (QOS) threshold.
